(19) United States
(12) Patent Application Publication
(10) Pub. No.: US 2021/0297405 A1
(43) Pub. Date: Sep. 23, 2021

(54) USER TERMINAL, CONTROL METHOD, AND STORAGE MEDIUM

(71) Applicant: HONDA MOTOR CO., LTD., Tokyo (JP)

(72) Inventors: Takayuki Ide, Wako-shi (JP); Koichi Yahagi, Wako-shi (JP)

(73) Assignee: HONDA MOTOR CO., LTD., Tokyo (JP)

(21) Appl. No.: 17/189,595

(22) Filed: Mar. 2, 2021

(30) Foreign Application Priority Data
Mar. 19, 2020 (JP) 2020-049461

(51) Int. Cl. H04L 29/06; H04L 12/24

(52) U.S. Cl. CPC H04L 63/083; H04L 41/22; H04L 63/102; H04L 63/20

(57) ABSTRACT

There is provided a user terminal. A storage unit stores login information in response to execution of a login operation with respect to the user terminal with use of a first account that has first user identification information. The login information indicates that a current login state is based on the first user identification information. In the current login state, a request unit requests a reset of authentication-purpose knowledge information for a second account that has second user identification information associated with the first user identification information by providing the first user identification information indicated by the login information to a reset server.

### CROSS-REFERENCE TO RELATED APPLICATION(S)

This application claims priority to and the benefit of Japanese Patent Application No. 2020-049461 filed on Mar. 19, 2020, the entire disclosure of which is incorporated herein by reference.

### BACKGROUND OF THE INVENTION

### Field of the Invention

The present invention relates to a user terminal, a control method, and a storage medium.

### Description of the Related Art

Today, systems and services that request a login using an account have become widespread. As one type of user authentication method for the time of login, an authentication method that uses knowledge information, such as a password (knowledge authentication), is known. In order to make use of knowledge authentication, a user needs to remember the knowledge information. Furthermore, as there is a case where the user forgets the knowledge information, a technique to reset (reissue) the knowledge information is necessary. For example, Japanese Patent Laid-Open No. 2005-182354 discloses a technique to perform identity confirmation based on user identification information (e.g., an email address, a company name, an individual's name, a telephone number, a mailing address, and so forth) that has been input by the user, and reissue a password.

In the case of the technique of Japanese Patent Laid-Open No. 2005-182354, as the user needs to input the user identification information by him/herself for identification confirmation, the user is subject to a large work load.

### SUMMARY OF THE INVENTION

The present invention has been made in view of the aforementioned situation, and provides a technique to reduce a work load on a user for resetting authentication-purpose knowledge information for an account.

According to an aspect of the present invention, there is provided a user terminal, comprising: a storage unit configured to store login information in response to execution of a login operation with respect to the user terminal with use of a first account that has first user identification information, the login information indicating that a current login state is based on the first user identification information; and a request unit configured to, in the current login state, request a reset of authentication-purpose knowledge information for a second account that has second user identification information associated with the first user identification information by providing the first user identification information indicated by the login information to a reset server.

### BRIEF DESCRIPTION OF THE DRAWINGS

FIG. 1 is a conceptual diagram of a network system 100.

FIG. 2 is a functional block diagram of a user terminal 200.

FIG. 3 is a functional block diagram of an authentication system 300.

FIG. 4 is a functional block diagram of a reset server 400.

FIG. 5 is a flowchart of processing executed by the user terminal 200.

FIG. 6 is a diagram showing an example of a chat screen.

FIG. 7 is a flowchart showing the details of chat processing (step S509 of FIG. 5).

FIG. 8 is a flowchart of processing executed by the reset server 400.

FIG. 9 is a flowchart of processing executed by the authentication system 300.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

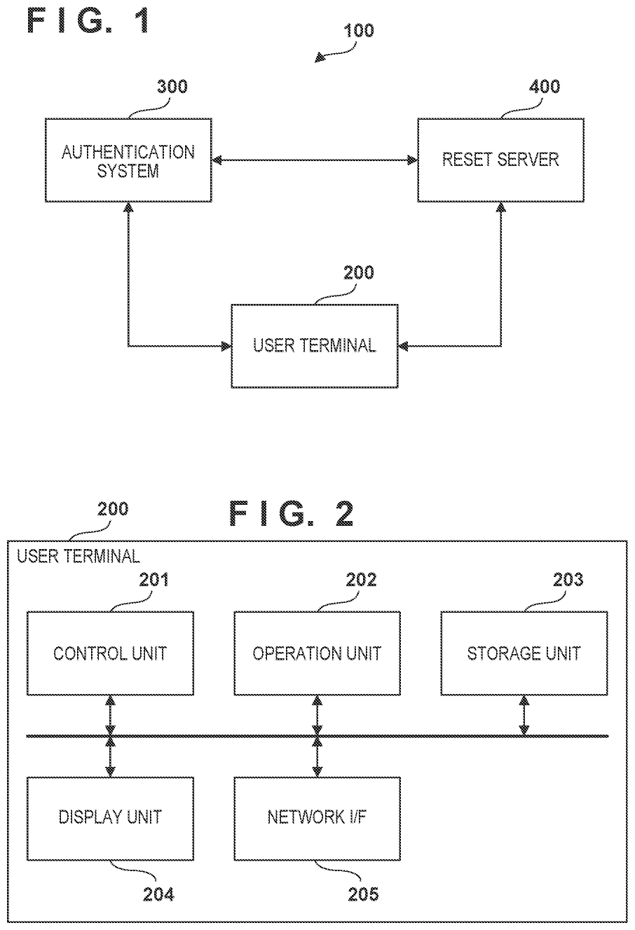

FIG. 1 is a conceptual diagram of a network system 100. In the network system 100, a user terminal 200, an authentication system 300, and a reset server 400 are connected to one another via a communication network, such as a LAN and the Internet.

The user terminal 200 is an electronic device, such as a personal computer (PC), a smartphone, and a tablet. It is assumed in the following description that the user terminal is a PC that is equipped with Windows® as an operating system (OS). A user can log into the user terminal 200 with use of his/her own account (hereinafter referred to as a “terminal account”). Although FIG. 1 shows only one user terminal 200, the network system 100 generally includes a plurality of user terminals 200. Note, although a “login” to an electronic device, such as a PC, may be expressed as a “logon” or a “sign-in”, the expression “login” is used in the present specification.

The authentication system 300 is a system that has a function of providing the user with a predetermined service via the user terminal 200, and a function of managing an account for allowing the user to log into this service (hereinafter referred to as a “service account”). Although FIG. 1 shows the authentication system 300 as one block, the authentication system 300 can be implemented using a plurality of computers that can communicate with one another. For example, the function of providing the service and the function of managing the account may be implemented using discrete computers.

The service account is an account that is different from the terminal account. Even with the same user, a password for the service account (a service password) is not necessarily identical to a password for the terminal account (a terminal password). On the other hand, with regard to user IDs (user identification information), there is association between the terminal account and the service account; a user ID for the service account (a service user ID) can be uniquely identified based on a user ID for the terminal account (a terminal user ID). In order to establish such association, for example, the same character string can be used for the service user ID and the terminal user ID of a single user.

Note, with regard to the terminal account, the user may be authenticated using other types of authentication method (e.g., biometric authentication based on biometric information, such as a fingerprint) instead of an authentication method based on knowledge information, such as a password (knowledge authentication).

The reset server 400 requests the authentication system 300 to reset the password (issue a new password) for the corresponding service account based on the terminal user ID provided from the user terminal 200. No particular limitation is intended with regard to a method of providing the terminal user ID from the user terminal 200 to the reset server 400. For example, the user terminal 200 may provide the terminal user ID by uploading the terminal user ID to a specific folder of a specific file server monitored by the reset server 400. Although it is assumed in the following description that the reset server 400 also has the functions of the file server, the file server may be a computer that is different from the reset server 400.

FIG. 2 is a functional block diagram of the user terminal 200. A control unit 201 includes, for example, a CPU, a ROM, a RAM, and the like, and controls the entirety of the user terminal 200 by executing various types of programs including the OS. An operation unit 202 includes, for example, such input devices as a keyboard and a mouse, and accepts an input operation performed by the user. A storage unit 203 includes, for example, a recording medium, such as an HDD and an SDD, and stores various types of programs including the OS. A display unit 204 includes, for example, a liquid crystal display, and displays user interfaces, various types of information, and so forth. A network I/F 205 is an interface for allowing the user terminal 200 to communicate with external apparatuses (the authentication system 300, the reset server 400, and the like).

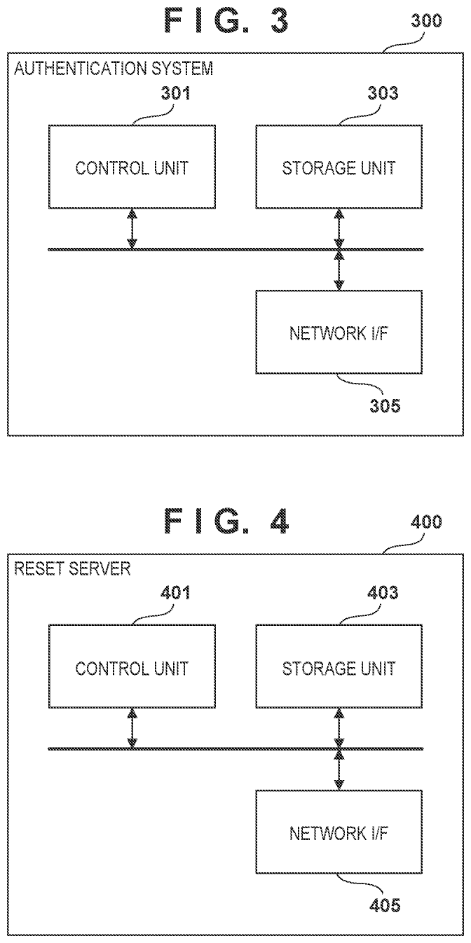

FIG. 3 is a functional block diagram of the authentication system 300. A control unit 301 includes, for example, a CPU, a ROM, a RAM, and the like, and controls the entirety of the authentication system 300 by executing various types of programs including an OS. A storage unit 303 includes, for example, a recording medium, such as an HDD and an SDD, and stores various types of programs including the OS. A network I/F 305 is an interface for allowing the authentication system 300 to communicate with external apparatuses (the user terminal 200, the reset server 400, and the like).

FIG. 4 is a functional block diagram of the reset server 400. A control unit 401 includes, for example, a CPU, a ROM, a RAM, and the like, and controls the entirety of the reset server 400 by executing various types of programs including an OS. A storage unit 403 includes, for example, a recording medium, such as an HDD and an SDD, and stores various types of programs including the OS. A network I/F 405 is an interface for allowing the reset server 400 to communicate with external apparatuses (the user terminal 200, the authentication system 300, and the like).

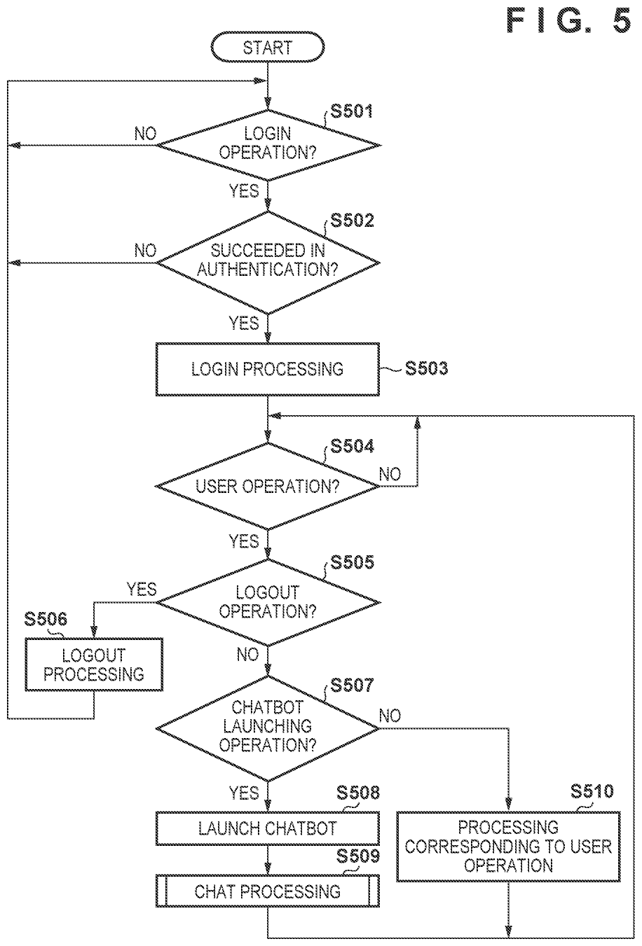

FIG. 5 is a flowchart of processing executed by the user terminal 200. In step S501, the control unit 201 waits until the user performs a login operation. The login operation includes the user's input of the terminal user ID and the terminal password with use of the operation unit 202. Once the login operation has been performed by the user, processing proceeds to step S502.

In step S502, the control unit 201 performs user authentication by verifying the terminal user ID and the terminal password input in step S501 based on a database of terminal accounts (a terminal account DB). The terminal account DB is held in, for example, the storage unit 303 of the authentication system 300. When the user authentication has succeeded, processing proceeds to step S503; when the user authentication has failed, processing returns to step S501.

In step S503, the control unit 201 performs login processing. The login processing includes processing for storing login information indicating that the current login state is based on the terminal user ID input in step S501. For example, the control unit 201 may store the terminal user ID into a storage area of the storage unit 203 designated by a predetermined variable or a predetermined address. In this case, the terminal user ID stored in this storage area, itself, plays the role of the login information.

In step S504, the control unit 201 waits until a user operation is performed via the operation unit 202. Once the user operation has been performed, processing proceeds to step S505.

In step S505, the control unit 201 determines whether the user operation performed in step S504 is a logout operation. When the user operation is the logout operation, processing proceeds to step S506; otherwise, processing proceeds to step S507.

In step S506, the control unit 201 performs logout processing. The logout processing includes processing for erasing the login information stored in step S503. Thereafter, processing returns to step S501.

In step S507, the control unit 201 determines whether the user operation performed in step S504 is an operation of launching a chatbot (a chatbot launching operation). The chatbot is a program that has a function of interacting with the user in accordance with programs, and is stored in the storage unit 203. When the user operation is the chatbot launching operation, processing proceeds to step S508; otherwise, processing proceeds to step S510.

In step S508, the control unit 201 launches the chatbot. In step S509, the control unit 201 performs chat processing. During the chat processing, the control unit 201 displays a chat screen on the display unit 204.

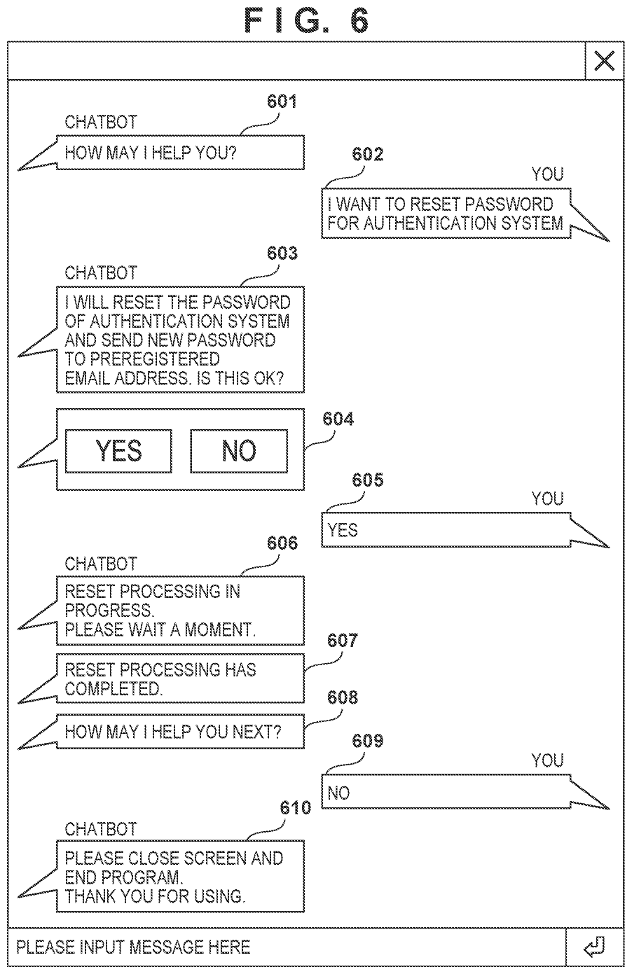

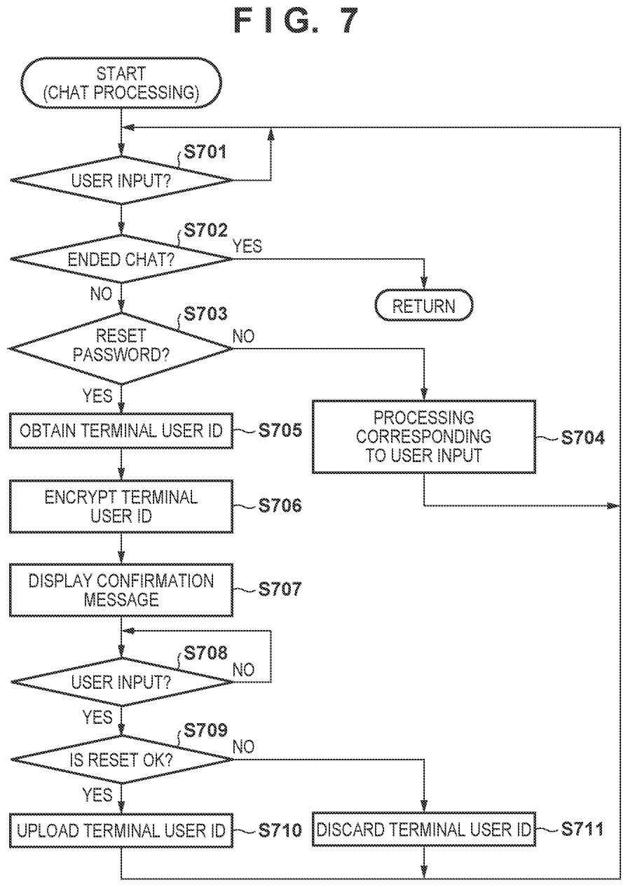

FIG. 6 is a diagram showing an example of the chat screen. As can be understood from FIG. 6, in the chat processing, the chatbot and the user interact with each other, and the control unit 201 executes processing in accordance with the content of the interaction (e.g., reset processing for the service password). At the start of the chat processing, the control unit 201 displays a message 601 shown in FIG. 6 (“How may I help you?”), and waits for a user input. After the chat processing has been executed, processing returns to step S504. The details of the chat processing will be described later with reference to FIG. 7.

Referring to FIG. 5 again, in step S510, the control unit 201 performs processing in accordance with the content of the user operation performed in step S504. Thereafter, processing returns to step S504.

Next, the details of the chat processing (step S509 of FIG. 5) will be described with reference to FIG. 7. During the chat processing, the control unit 201 displays messages sequentially in accordance with user inputs. The chat screen of FIG. 6 shows examples of messages of the chatbot and messages input by the user.

In step S701, the control unit 201 waits until a user input is performed via the operation unit 202. Once the user input has been performed, processing proceeds to step S702.

In step S702, the control unit 201 determines whether the user input performed in step S701 is an input that represents an instruction for ending the chat. For example, when a message 609 (“None”) has been input in response to the message 601 shown in FIG. 6, it is determined that the user input is the input that represents the instruction for ending the chat. When the user input is the input that represents the instruction for ending the chat, the chat processing is ended, and processing returns to step S504 of FIG. 5. At the end of the chat processing, the control unit 201 may display a message 610. When the user input is not the input that represents the instruction for ending the chat, processing proceeds to step S703.

In step S703, the control unit 201 determines whether the user input performed in step S701 is an input that represents an instruction for resetting the service password (an input of a reset instruction). For example, when a message 602 (“I want to reset the password for the authentication system”) has been input in response to the message 601 shown in FIG. 6, it is determined that the user input is the input of the reset instruction. When the user input is the input of the reset instruction, processing proceeds to step S705; otherwise, processing proceeds to step S704.

In step S704, the control unit 201 performs processing in accordance with the content of the user input performed in step S701. Thereafter, processing returns to step S701.

In step S705, the control unit 201 obtains the terminal user ID indicated by the login information that was stored in the login processing of step S503.

In step S706, the control unit 201 encrypts the terminal user ID obtained in step S705. No particular limitation is intended with regard to an encryption method, and an encryption method based on any known encryption technique can be used. Note that the encryption may be omitted depending on security requirements.

In step S707, the control unit 201 displays a confirmation message. The confirmation message is, for example, a message that asks the user whether the password is to be reset (a message that prompts the user to approve the execution of the reset), such as a message 603 shown in FIG. 6. In addition, the control unit 201 may display options for an answer to the confirmation message, such as a message 604.

In step S708, the control unit 201 waits until a user input (an input of an answer to the confirmation message) is performed via the operation unit 202. The user may input the answer by way of a text input using the keyboard included in the operation unit 202, or may input the answer by clicking an option in the message 604 using the mouse included in the operation unit 202. Once the user input has been performed, processing proceeds to step S709.

In step S709, the control unit 201 determines whether the user input performed in step S708 is an input that approves the execution of the reset (e.g., a message 605). When the user input is the input that approves the execution of the reset, processing proceeds to step S710; otherwise, processing proceeds to step S711.

In step S710, the control unit 201 uploads the encrypted terminal user ID to a specific folder of the storage unit 403 of the reset server 400, which functions as the file server. Thereafter, processing returns to step S701. Note that the control unit 201 may display messages 606 to 608 in accordance with the progress of processing of steps S710 to S701.

In step S711, the control unit 201 discards the encrypted terminal user ID. Thereafter, processing returns to step S701.

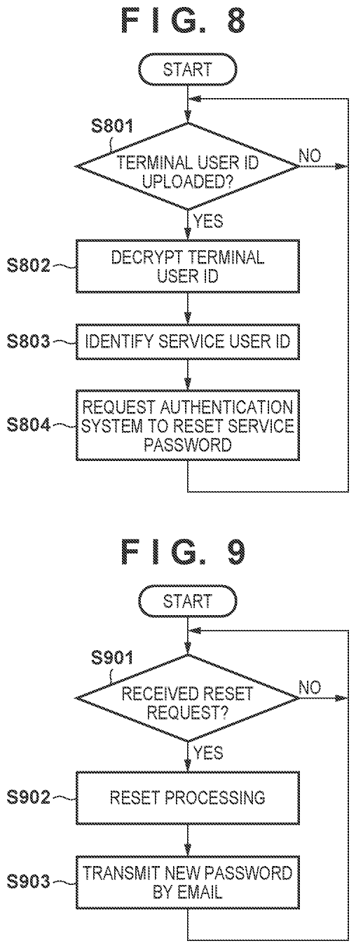

FIG. 8 is a flowchart of processing executed by the reset server 400. In step S801, the control unit 401 waits until the encrypted terminal user ID is uploaded to the specific folder of the storage unit 403. Once the encrypted terminal user ID has been uploaded to the specific folder of the storage unit 403, processing proceeds to step S802.

In step S802, the control unit 401 decrypts the encrypted terminal user ID. In step S803, the control unit 401 identifies the service user ID based on the terminal user ID. For example, a database in which the terminal user ID and the service user ID are associated with each other is stored in the storage unit 403, and the control unit 401 can identify the service user ID by referring to this database.

In step S804, the control unit 401 requests the authentication system 300 to reset the service password corresponding to the service user ID that was identified in step S803. Thereafter, processing returns to step S801.

FIG. 9 is a flowchart of processing executed by the authentication system 300. In step S901, the control unit 301 waits until a request for resetting the service password corresponding to a specific terminal user ID (a reset request) is received from the reset server 400. Once the reset request has been received, processing proceeds to step S902.

In step S902, the control unit 301 executes reset processing for the service password. The reset processing includes processing for disabling the current service password and issuing a new service password.

In step S903, the control unit 301 transmits the new service password issued in step S902 by email to an email address linked to the terminal user ID. This enables the user to obtain the new service password. Thereafter, processing returns to step S901.

Note that processing of steps S802 and S803 of FIG. 8 may be executed by the authentication system 300 instead of the reset server 400. In this case, the reset server 400 provides the encrypted terminal user ID to the authentication system 300 when requesting the authentication system 300 for the reset. Furthermore, although it is assumed in the foregoing description that the authentication system 300 and the reset server 400 are separated from each other, the authentication system 300 may include the reset server 400.

The foregoing configuration enables the user to reset the service password without inputting user identification information by him/herself.

### Summary of Embodiments

The foregoing embodiments disclose at least the following user terminal, control method, and storage medium.

Item 1

A user terminal (200), comprising:

a storage unit (201) configured to store login information in response to execution of a login operation with respect to the user terminal (200) with use of a first account that has first user identification information, the login information indicating that a current login state is based on the first user identification information; and

a request unit (201) configured to, in the current login state, request a reset of authentication-purpose knowledge information for a second account that has second user identification information associated with the first user identification information by providing the first user identification information indicated by the login information to a reset server (400).

According to this embodiment, a work load on a user for resetting authentication-purpose knowledge information for an account can be reduced. Furthermore, as a reset request is made in the login state based on the login operation that uses the first account, a fraudulent reset request by a third party can be restrained.

Item 2

The user terminal (200) according to item 1,

wherein the request unit (201) provides the first user identification information to the reset server (400) after encrypting the first user identification information.

According to this embodiment, security can be improved.

Item 3

The user terminal (200) according to item 1, further comprising

an interaction unit (201) configured to interact with a user with use of a chatbot,

wherein the request unit (201) requests the reset server (400) for the reset in response to issuance of a reset instruction by the user through the interaction.

According to this embodiment, the user can make a reset request through an intuitive operation.

Item 4

The user terminal (200) according to item 1, further comprising

an interaction unit (201) configured to interact with a user with use of a chatbot,

wherein the interaction unit (201) displays a message that prompts the user to approve execution of the reset in response to issuance of a reset instruction by the user through the interaction, and

the request unit (201) requests the reset server (400) for the reset in response to approval of execution of the reset given by the user.

According to this embodiment, a reset request made by an erroneous operation by the user can be restrained.

Item 5

A control method for a user terminal (200), comprising:

storing (S501-S503) login information in response to execution of a login operation with respect to the user terminal (200) with use of a first account that has first user identification information, the login information indicating that a current login state is based on the first user identification information; and

in the current login state, requesting (S710) a reset of authentication-purpose knowledge information for a second account that has second user identification information associated with the first user identification information by providing the first user identification information indicated by the login information to a reset server (400).

According to this embodiment, a work load on a user for resetting authentication-purpose knowledge information for an account can be reduced. Furthermore, as a reset request is made in the login state based on the login operation that uses the first account, a fraudulent reset request by a third party can be restrained.

Item 6

A non-transitory computer-readable storage medium which stores a program for causing a computer of a user terminal (200) to execute a control method comprising:

storing (S501-S503) login information in response to execution of a login operation with respect to the user terminal (200) with use of a first account that has first user identification information, the login information indicating that a current login state is based on the first user identification information; and

in the current login state, requesting (S710) a reset of authentication-purpose knowledge information for a second account that has second user identification information associated with the first user identification information by providing the first user identification information indicated by the login information to a reset server (400).

According to this embodiment, a work load on a user for resetting authentication-purpose knowledge information for an account can be reduced. Furthermore, as a reset request is made in the login state based on the login operation that uses the first account, a fraudulent reset request by a third party can be restrained.

Note that no particular limitation is intended with regard to the specific configurations of software and hardware for implementing various types of functions that have been described in the foregoing embodiments. Arbitrary software, arbitrary hardware, and an arbitrary combination of arbitrary software and arbitrary hardware are encompassed within the scope of the foregoing embodiments, as long as they are technically possible.

Although the embodiments of the invention have been described above, the invention is not limited to the foregoing embodiments, and various variations/changes are possible within the spirit of the invention.

What is claimed is:

1. A user terminal, comprising:
a storage unit configured to store login information in response to execution of a login operation with respect to the user terminal with use of a first account that has first user identification information, the login information indicating that a current login state is based on the first user identification information; and
a request unit configured to, in the current login state, request a reset of authentication-purpose knowledge information for a second account that has second user identification information associated with the first user identification information by providing the first user identification information indicated by the login information to a reset server.

2. The user terminal according to claim 1,
wherein the request unit provides the first user identification information to the reset server after encrypting the first user identification information.

3. The user terminal according to claim 1, further comprising
an interaction unit configured to interact with a user with use of a chatbot,
wherein the request unit requests the reset server for the reset in response to issuance of a reset instruction by the user through the interaction.

4. The user terminal according to claim 1, further comprising
an interaction unit configured to interact with a user with use of a chatbot,
wherein the interaction unit displays a message that prompts the user to approve execution of the reset in response to issuance of a reset instruction by the user through the interaction, and
the request unit requests the reset server for the reset in response to approval of execution of the reset given by the user.

5. A control method for a user terminal, comprising:
storing login information in response to execution of a login operation with respect to the user terminal with use of a first account that has first user identification information, the login information indicating that a current login state is based on the first user identification information; and
in the current login state, requesting a reset of authentication-purpose knowledge information for a second account that has second user identification information associated with the first user identification information by providing the first user identification information indicated by the login information to a reset server.

6. A non-transitory computer-readable storage medium which stores a program for causing a computer of a user terminal to execute a control method comprising:
storing login information in response to execution of a login operation with respect to the user terminal with use of a first account that has first user identification information, the login information indicating that a current login state is based on the first user identification information; and
in the current login state, requesting a reset of authentication-purpose knowledge information for a second account that has second user identification information associated with the first user identification information by providing the first user identification information indicated by the login information to a reset server.
